(19) United States
(12) Patent Application Publication
(10) Pub. No.: US 2015/0341397 A1
(43) Pub. Date: Nov. 26, 2015

(54) DATA SHARING SYSTEM AND METHOD

(71) Applicant: GOOGLE INC., Mountain View, CA (US)

(72) Inventor: Christopher Semturs, Seemattweg (CH)

(73) Assignee: GOOGLE INC., Mountain View, CA (US)

(21) Appl. No.: 13/664,858

(22) Filed: Oct. 31, 2012

(51) Int. Cl. H04L 29/06; G06F 3/0484; H04L 29/08; G06F 3/0482

(52) U.S. Cl. CPC H04L 65/403; G06F 3/0482; G06F 3/04842; H04L 67/02

(57) ABSTRACT

A method and computing system for defining an unrestricted web-based space on a computing device for sharing media content within a social network. The unrestricted web-based space is accessible by non-users of the social network. First media content is received from a first user of the social network. The first media content is shared within the unrestricted web-based space. The first user is enabled to provide location information concerning the unrestricted web-based space to a non-user of the social network.

### TECHNICAL FIELD

This disclosure relates to social network events within a social network and, more particularly, to the sharing of media with non-users of the social network.

### BACKGROUND

The Internet currently allows for the free exchange of ideas and information in a manner that was unimaginable only a couple of decades ago. One such use for the Internet is as a communication medium, whether it is via one-on-one exchanges or multi-party exchanges. For example, two individuals may exchange private emails with each other. Alternatively, multiple people may participate on a public website in which they may post entries that are published for multiple people to read. Examples of such websites may include but are not limited to product/service review sites and topical blogs.

As is known in the art, the phrase social network may be used to refer to a group of technologies (e.g. Web-based and mobile technologies) that allow for users to engage in a quasi-real-time, interactive dialogue. Social networking websites have allowed people to interact and socialize in ways that were unimaginable ten years ago. For example, the use of such social networking websites has allowed for long lost friends to be reunited, long-distance friendships to be easily maintained, and information to be broadcast to groups of people. Further and through the use of such social networks, friends may share media content (e.g., videos and photographs) with each other. Unfortunately, a prerequisite to sharing such media content is often that any party participating in the sharing must be a member of the social network.

### SUMMARY OF DISCLOSURE

In one implementation, a computer-implemented method includes defining an unrestricted web-based space on a computing device for sharing media content within a social network. The unrestricted web-based space is accessible by non-users of the social network and is associated with a social network event that is being attended by a first user of the social network. First media content is received from the first user. The first media content is chosen from the group consisting of: an audio file; a video file; an audio-video file; and a still photograph. The first media content is shared within the unrestricted web-based space. The first user is enabled to provide location information concerning the unrestricted web-based space to a non-user of the social network. The non-user is enabled to view the first media content shared within the unrestricted web-based space.

In another implementation, a computer-implemented method includes defining an unrestricted web-based space on a computing device for sharing media content within a social network. The unrestricted web-based space is accessible by non-users of the social network. First media content is received from a first user of the social network. The first media content is shared within the unrestricted web-based space. The first user is enabled to provide location information concerning the unrestricted web-based space to a non-user of the social network.

One or more of the following features may be included. The first media content may be chosen from the group consisting of: an audio file; a video file; an audio-video file; and a still photograph. The location information may be a URL. The non-user may be enabled to view the first media content shared within the unrestricted web-based space. Second media content may be received from the non-user. The second media content may be shared within the unrestricted web-based space. The first user may be enabled to view the second media content shared within the unrestricted web-based space. The second media content is chosen from the group consisting of: an audio file; a video file; an audio-video file; and a still photograph. The unrestricted web-based space may be associated with a social network event. The social network event may being attended by the first user

In another implementation, a computing system including a processor and memory is configured to perform operations including defining an unrestricted web-based space on a computing device for sharing media content within a social network. The unrestricted web-based space is accessible by non-users of the social network. First media content is received from a first user of the social network. The first media content is shared within the unrestricted web-based space. The first user is enabled to provide location information concerning the unrestricted web-based space to a non-user of the social network.

One or more of the following features may be included. The first media content may be chosen from the group consisting of: an audio file; a video file; an audio-video file; and a still photograph. The location information may be a URL. The non-user may be enabled to view the first media content shared within the unrestricted web-based space. Second media content may be received from the non-user. The second media content may be shared within the unrestricted web-based space. The first user may be enabled to view the second media content shared within the unrestricted web-based space. The second media content is chosen from the group consisting of: an audio file; a video file; an audio-video file; and a still photograph. The unrestricted web-based space may be associated with a social network event. The social network event may be being attended by the first user

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a data sharing process according to an implementation of the present disclosure;

FIG. 2 is a flowchart of the data sharing process of FIG. 1 according to an implementation of the present disclosure;

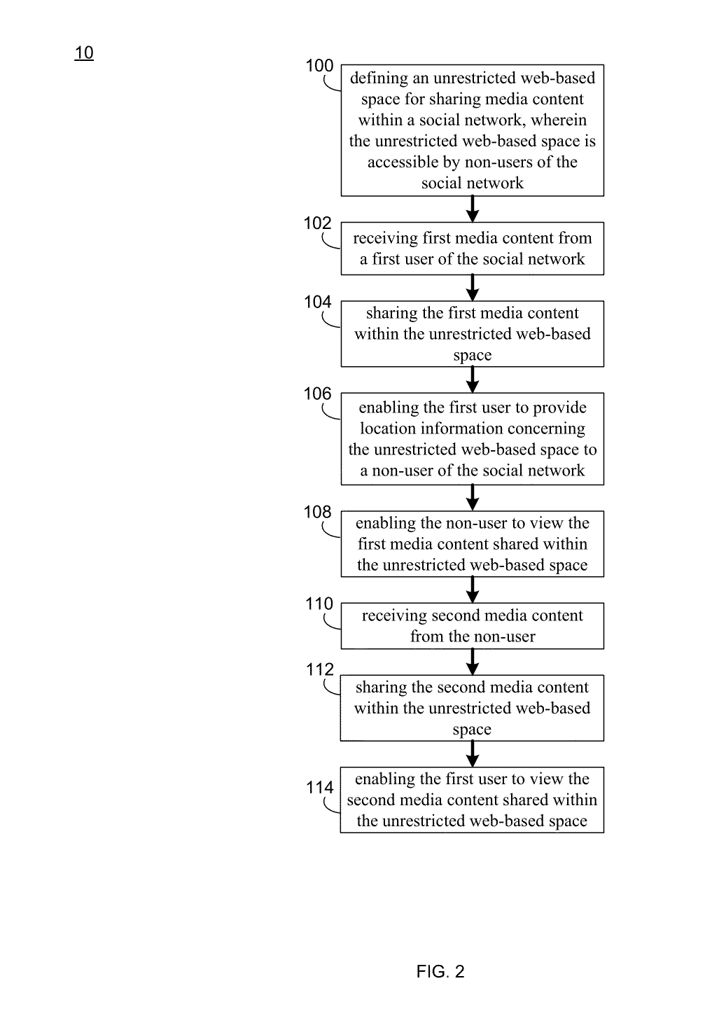

FIG. 3A is a diagrammatic view of a display screen rendered by the data sharing process of FIG. 1 according to an implementation of the present disclosure;

FIG. 3B is a diagrammatic view of a display screen rendered by the data sharing process of FIG. 1 according to an implementation of the present disclosure; and

FIG. 4 is a diagrammatic view of the computing device of FIG. 1 according to an implementation of the present disclosure.

Like reference symbols in the various drawings indicate like elements.

### DETAILED DESCRIPTION OF THE PREFERRED IMPLEMENTATIONS

People may use social networks to share photographs with each other. And when multiple people attend a social event defined within a social network, these people may each upload photographs concerning the social event to a shared photography pool that is accessible by all of the people who attended the social event. Unfortunately, such systems often require contributors to be members of the social network. This disclosure concerns a novel manner in which photographs within a social network may be shared with non-users of the social network. For example, a user of the social network may define an unrestricted web-based space for sharing media content with non-users of the social network. This unrestricted web-based space may be accessible by such non-users of the social network. Media content (e.g., audio files; video files; audio-video files; and still photographs) may be uploaded by the user and placed within the unrestricted web-based space for sharing with the non-users of the social network. The user may provide location information (e.g., in the form of a complex, non-indexed URL) concerning the unrestricted web-based space to a non-user of the social network. Accordingly, the non-user of the social network may access the unrestricted web-based space and view the media content shared within the unrestricted web-based space by the user.

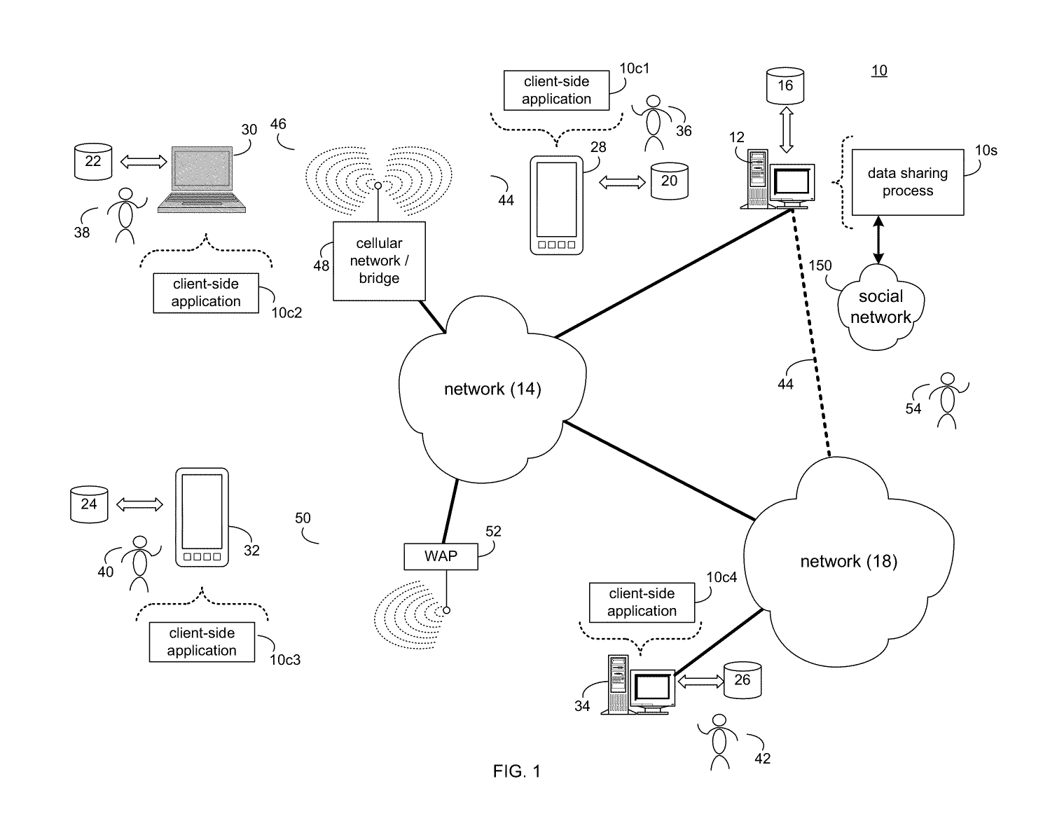

In FIGS. 1 & 2, there is shown data sharing process 10. Data sharing process 10 may be implemented as a server-side process, a client-side process, or a hybrid server-side/client-side process. For example, data sharing process 10 may be implemented as a purely server-side process via data sharing process 10s. Alternatively, data sharing process 10 may be implemented as a purely client-side process via one or more of client-side application 10c1, client-side application 10c2, client-side application 10c3, and client-side application 10c4. Alternatively still, data sharing process 10 may be implemented as a hybrid server-side/client-side process via data sharing process 10s in combination with one or more of client-side application 10c1, client-side application 10c2, client-side application 10c3, and client-side application 10c4. Accordingly, data sharing process 10 as used in this disclosure may include any combination of data sharing process 10s, client-side application 10c1, client-side application 10c2, client-side application 10c3, and client-side application 10c4.

As will be discussed below in greater detail, data sharing process 10 may define 100 an unrestricted web-based space on a computing device for sharing media content within a social network. The unrestricted web-based space may be accessible by non-users of the social network. First media content may be received 102 from a first user of the social network. The first media content may be shared 104 within the unrestricted web-based space. The first user may be enabled 106 to provide location information concerning the unrestricted web-based space to a non-user of the social network.

Data sharing process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of data sharing process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to a web browser, a game console user interface, or a specialized application (e.g., an application running on e.g., the Android™ platform or the iPhone™ platform). The instruction sets and subroutines of client-side applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access data sharing process 10 directly through network 14 or through secondary network 18. Further, data sharing process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As is known in the art, users of social networks (e.g., Google+™) may be able to schedule social network events, wherein a social network event is a group activity in which people get together for a specific purpose. Examples of such social network events may include but are not limited to: a group of friends getting together for drinks, several people going to a baseball game together, an end of summer party at a person's house, and a concert at a local arena. While the above discussion concerns Google+™, this is for illustrative purposes only and is not intended to be a limitation of this disclosure. For example, data sharing process 10 may be included within or utilized by any social networking website.

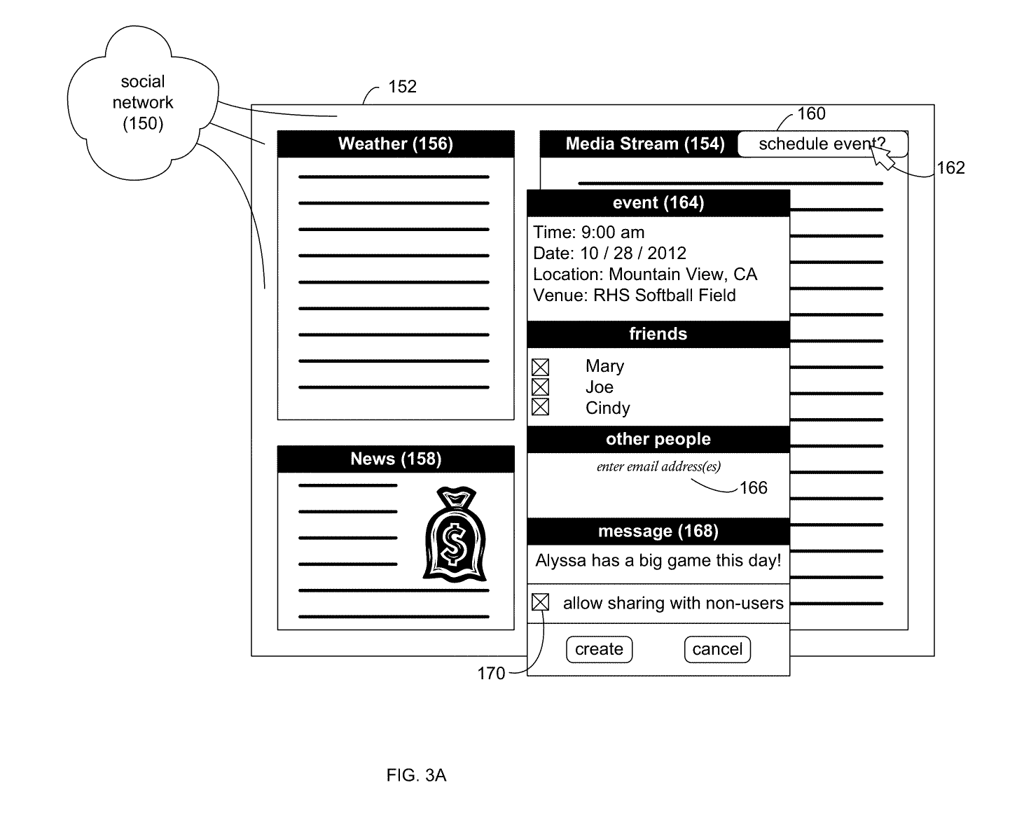

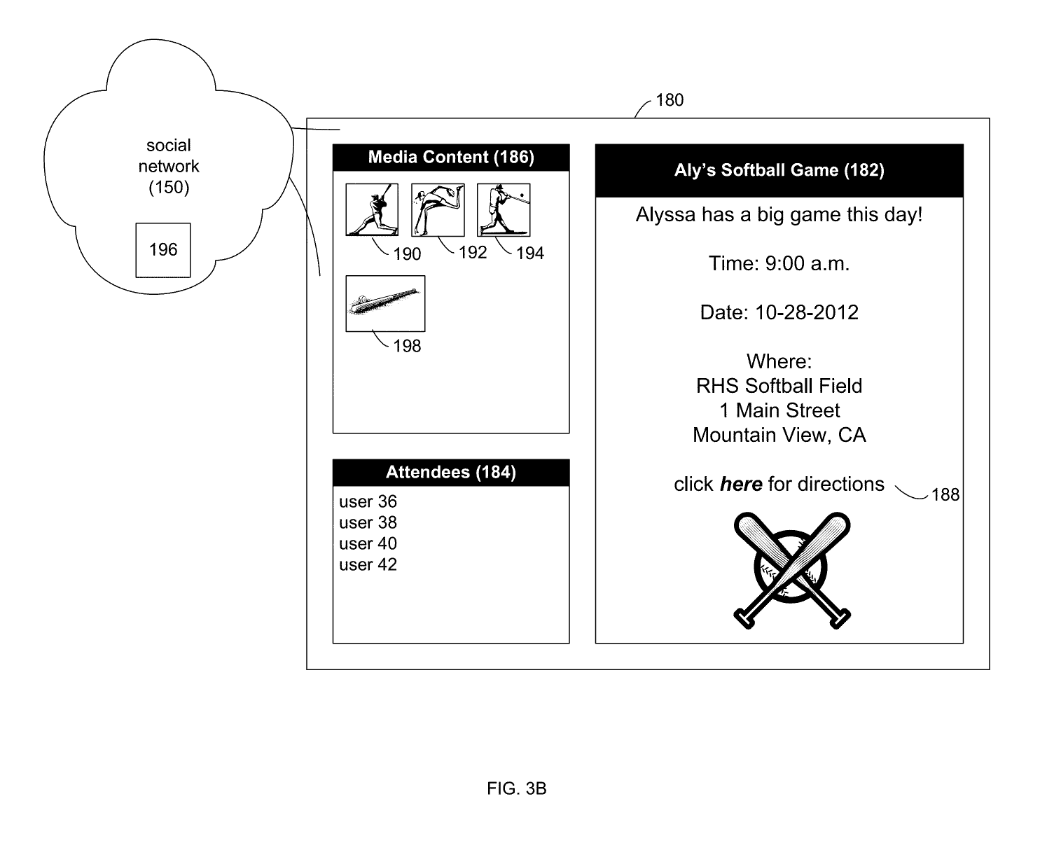

Referring also to FIG. 3A, data sharing process 10 may be included within, executed within, or a portion of a social network (e.g., social network 150). The phrase social network may be used to refer to a group of technologies (e.g. web-based and mobile technologies) that allow for users to engage in a quasi-real-time, interactive dialogue.

For illustrative purposes, assume that user 36 is planning on attending their daughter's softball game the following Saturday and would like to share photographs and videos from the game. Accordingly, data sharing process 10 (in conjunction with social network 150) may be configured to allow user 36 to define/schedule a social network event for this softball game. For example, social network 150 may include graphical user interface 152, which may be divided into a plurality of sections, such as media stream 154, weather 156, and news 158. To schedule a social network event, user 36 may select e.g., schedule event button 160 using onscreen pointer 162 (which is controllable via a mouse, not shown).

Upon user 36 making this selection, data sharing process 10 may render event window 164 that may be configured to define a scheduled time/date/location/venue for the social network event and may allow user 36 to identify invitee(s) for the social network event e.g., Aly's Softball Game.

Event window 164 may be configured to allow user 36 to define a time/date/location/venue for the social network event. Accordingly, user 36 may enter the appropriate time (e.g., 9:00 a.m.)/date (e.g., 10-28-2012)/location (e.g., Mountain View, Calif.)/venue (e.g., RHS Softball Field) into the “Time”, “Date”, “Location” and “Venue” fields of event window 164.

Event window 164 may further be configured to allow user 36 to invite various types of individuals to the social network event. For example, event window 164 may be configured to identify members of social network 150 that are friends with/connected to/in a circle with user 36. For example, assume that user 36 is friends with Mary (user 38), Joe (user 40), and Cindy (user 42).

In the event that user 36 wishes to invite any of users 38, 40, 42 to join the social network event, user 36 may check the appropriate check box next to the name of the user(s) that they wish to invite.

Additionally, event window 164 may be configured to allow user 36 to invite people that are not members of social network 150. Accordingly, user 36 may populate email field 166 with the email address(es) of people that that they wish to invite to join the social network event e.g., Aly's Softball Game but are currently not members of social network 150. Additionally/alternatively, event window 164 may be further configured to allow user 36 to invite people that are not members of social network 150 via e.g., a phone number (i.e., in the form of a text message) or some other unique identifier (e.g., an ID on another network, a Twitter™ account, etc.).

Event window 164 may include message field 168 that may allow user 36 to define a text-based comment concerning the social network event. For example, user 36 may add the comment “Alyssa has a big game this day!” Accordingly, this text-based comment may be used as a descriptor for the social network event e.g., Aly's Softball Game.

Further, event window 164 may allow user 36 to define whether non-users of social network 150 may share (e.g., upload and download) media associated with the social network event e.g., Aly's Softball Game. Accordingly, if user 36 wishes to allow for such non-user participation, user 36 may select check box 170 (via onscreen pointer 162).

Once the appropriate people are identified within event window 164, user 36 may select (via onscreen pointer 162) the “create” button included within event window 164, thus creating the social network event e.g., Aly's Softball Game and sending out the appropriate invitations.

Referring also to FIG. 3B and upon user 36 selecting the “create” button, data sharing process 10 may generate an event webpage (e.g. event webpage 180) for the social network event e.g., Aly's Softball Game. Further, data sharing process 10 may render event webpage 180 associated with the social network event e.g., Aly's Softball Game in response to a user (e.g. one or more of users 36, 38, 40, 42) or a third party visiting event webpage 180. Event webpage 180 may include a plurality of sections, examples of which may include but are not limited to event section 182, attendee section 184 and media content section 186.

Event section 182 may be configured to provide visitors of event webpage 180 with information concerning the social network event e.g., Aly's Softball Game. For example, event section 182 may include the original message defined within message field 168, namely “Alyssa has a big game this day!” Further, event section 182 may define a time/date/location/venue for the social network event (e.g., 9:00 a.m. on 10-28-2012 in Mountain View, Calif. @ RHS Softball Field). Further, event section 182 may include direction link 188 that may allow a visitor to event webpage 180 to obtain directions to the event venue (e.g. RHS Softball Field).

Attendee section 184 may be configured to define the people who are attending the social network event e.g., Aly's Softball Game. For example, attendee section 184 may be configured to provide a visitor to event webpage 180 with a list that identifies the individuals who were invited to the social network event e.g., Aly's Softball Game and a list that identifies the individuals who have confirmed their attendance at the social network event e.g., Aly's Softball Game.

Media content section 186 may be configured to display media content that is associated with the social network event e.g., Aly's Softball Game. Examples of such media content may include audio files (e.g., an audio recording of the singing of the National Anthem before the game); video files (e.g., a video recording of a play during the game); audio-video files (e.g., an audio-video recording the last inning of the game); and still photographs (e.g., photographs 190, 192, 194).

As discussed above, by selecting checkbox 170 within event window 164, user 36 may define whether non-users of social network 150 may share (e.g., upload and download) media associated with the social network event e.g., Aly's Softball Game. Accordingly, if user 36 selects checkbox 170, data sharing process 10 define 100 an unrestricted web-based space (e.g., unrestricted web-based space 196) on a computing device (e.g., computing device 12) for sharing media content (e.g., photographs 190, 192, 194) within social network 150. Unrestricted web-based space 196, which may be accessible by non-users of the social network, may be a directory within e.g., computing device 12 (or some other server/storage device) that is accessible via social network 150 and into which media may be copied for sharing purposes. Further, unrestricted web-based space 196 may be a non-indexed webpage that would not be located via a search engine. Accordingly, while unrestricted web-based space 196 is not a restricted area, unrestricted web-based space 196 may be a quasi-private space due to it being undiscoverable via search engines.

Assume for illustrative purposes that while attending the social network event e.g., Aly's Softball Game, user 36 meets an attendee of the social network event (e.g. attendee 54) who was attending the softball game because their daughter is also on the softball team. However, attendee 54 is not a user of social network 150.

Further, assume that during the social network event e.g., Aly's Softball Game, user 36 is generating media content (e.g. photographs 190, 192, 194) and uploading the same to social network 150. Accordingly, data sharing process 10 may receive 102 first media content (e.g. photographs 190, 192, 194) from user 36 and may share 104 the first media content (e.g. photographs 190, 192, 194) within unrestricted web-based space 196.

Assume for illustrative purposes that during the course of the social network event e.g., Aly's Softball Game, user 36 and attendee 54 begin to talk and decided they would like to share their photographs of the event. As discussed above, upon user 36 uploading photographs 190, 192, 194, photographs 190, 192, 194 may be stored within unrestricted web-based space 196 and visible via media content section 186 of event webpage 180.

Data sharing process 10 may enable 106 user 36 to provide location information concerning unrestricted web-based space 196 to non-users of social network 150 (e.g. attendee 54). Accordingly, through the use of unrestricted web-based space 196, non-users of social network 150 may be able to share media with users of social network 150 without being required to join social network 150. Providing the location information to attendee 54 may be accomplished in various ways such as “handshaking” client electronic devices 28 being used by user 36 and the client electronic device (not shown) being used by attendee 54. This “handshake” may be achieved in multiple ways, examples of which may include but are not limited to client electronic device 28 IR beaming the pertinent information to the client electronic device (not shown) of attendee 54; client electronic device 28 displaying a barcode (not shown) that may be scanned by the client electronic device (not shown) of attendee 54; client electronic device 28 sending an e-mail/text message (not shown) to the client electronic device (not shown) of attendee 54; or client electronic device 28 displaying information that may be manually typed into the client electronic device (not shown) of attendee 54. Regardless of the type of handshake, the data provided to attendee 54 by user 36 may contain a URL (or a shortened URL) that may direct attendee 54 to unrestricted web-based space 196.

While the social network event e.g., Aly's Softball Game is described above as being created within social network 150 prior to the occurrence of the event, this is for illustrative purposes only and is not intended to be a limitation of this disclosure as other configurations are possible and are considered to be within the scope of this disclosure and the claims. For example, the social network event may be created in an ad-hoc fashion in response to the above-described handshake operation.

For example, assume that user 36 is attending the social network event e.g., Aly's Softball Game and taking several photographs (e.g. photographs 190, 192, 194). Further, assume that prior to meeting attendee 54, user 36 did not intend to share photographs 190, 192, 194. However, upon meeting attendee 54, user 36 and attendee 54 decided to share their photos amongst each other. Accordingly, user 36 may initiate the above-described handshaking procedure, which may in turn result in: the defining 100 of unrestricted web-based space 196; the receiving 102 of photographs 190, 192, 194 from user 36, the sharing 104 of photographs 190, 192, 194 within unrestricted web-based space 196, and user 36 being enabled 106 to provide location information to attendee 54 concerning unrestricted web-based space 196.

Data sharing process 10 may also enable 108 the non-user (e.g. attendee 54) to view the first media content (e.g. photographs 190, 192, 194) shared within unrestricted web-based space 196. Accordingly, attendee 54 may visit event webpage 180 and view photographs 190, 192, 194 that appear within media content section 186 of event webpage 180 and are stored within unrestricted web-based space 196.

Additionally, data sharing process 10 may be configured to receive 110 second media content (e.g. photograph 198) from non-users (e.g. attendee 54) of social network 150. For example, assume that attendee 54 is also taking photographs at the social network event and that attendee 54 would like to share photograph 198 with user 36. Accordingly, attendee 54 may upload photograph 198, which may be received 110 by data sharing process 10.

Data sharing process 10 may share 112 the second media content (e.g. photograph 198) within unrestricted web-based space 196, which may appear within media content section 186 of event webpage 180. Further, data sharing process 10 may enable 114 the first user (e.g. user 36) to view the second media content (e.g. photograph 198) shared within unrestricted web-based space 196. Accordingly, user 36 may visit event webpage 180 and view photograph 198 that appears within media content section 186 of event webpage 180 and is stored within unrestricted web-based space 196.

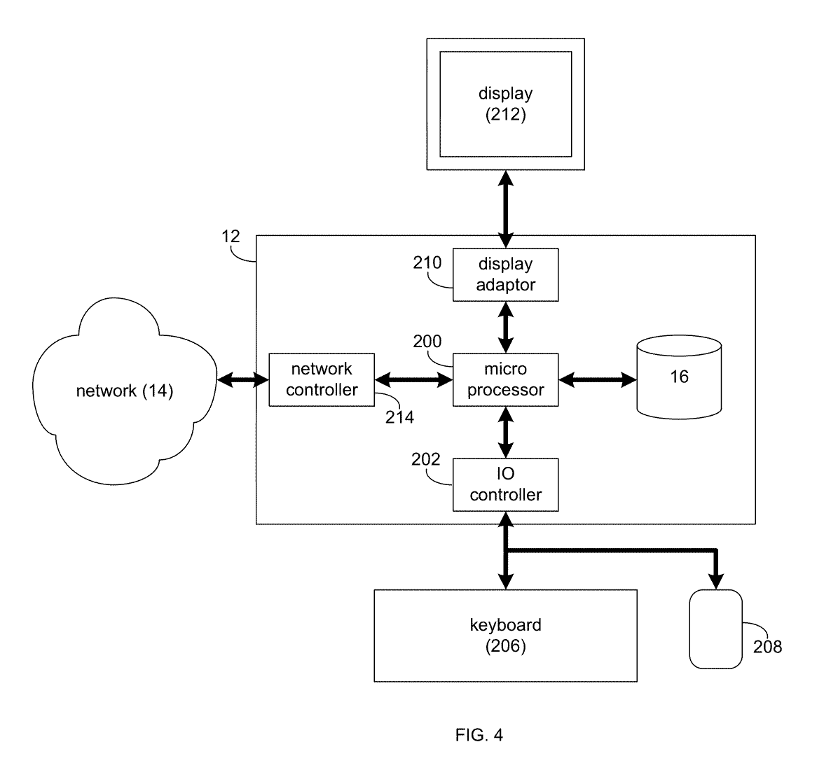

Referring also to FIG. 4, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, data sharing process 10 may be substituted for computing device 12 within FIG. 4, examples of which may include but are not limited to client electronic devices 28, 30, 32, 34.

Computing system 12 may include microprocessor 200 configured to e.g., process data and execute instructions/code for data sharing process 10. Microprocessor 200 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. JO controller 202 may be configured to couple microprocessor 200 with various devices, such as keyboard 206, mouse 208, USB ports (not shown), and printer ports (not shown). Display adaptor 210 may be configured to couple display 212 (e.g., a CRT or LCD monitor) with microprocessor 200, while network adapter 214 (e.g., an Ethernet adapter) may be configured to couple microprocessor 200 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 200) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The implementation was chosen and described in order to best explain the principles of the disclosure and the practical application, and to enable others of ordinary skill in the art to understand the disclosure for various implementations with various modifications as are suited to the particular use contemplated.

Having thus described the disclosure of the present application in detail and by reference to implementations thereof, it will be apparent that modifications and variations are possible without departing from the scope of the disclosure defined in the appended claims.

What is claimed is:

1. A computer-implemented method comprising:
generating a social network event on a social network, wherein the social network event corresponds to a physical location and wherein the social network event is attended by a first user of the social network;
sending an electronic invitation to a non-user of the social network to the social network event;
defining an unrestricted web-based space that is associated with the social network event on a computing device for sharing media content within the social network, wherein the unrestricted web-based space is accessible by the non-user of the social network;
receiving first media content that is associated with the social network event from the first user, wherein the first media content is chosen from the group consisting of: an audio file a video file an audio-video file and a still photograph;
sharing the first media content within the unrestricted web-based space;
enabling the first user to provide electronic location information concerning the unrestricted web-based space to the non-user of the social network; and
enabling the non-user to view the first media content shared within the unrestricted web-based space.

2. A computer-implemented method comprising:
generating a social network event on a social network, wherein the social network event corresponds to a physical location and wherein the social network event is attended by a first user of the social network
sending an electronic invitation to a non-user of the social network to the social network event;
defining an unrestricted web-based space that is associated with the social network event on a computing device for sharing media content within the social network that is associated with the social network event, wherein the unrestricted web-based space is accessible by the non-user of the social network;
receiving first media content that is associated with the social network event from the first user of the social network;
sharing the first media content within the unrestricted web-based space; and
enabling the first user to provide electronic location information concerning the unrestricted web-based space to a non-user of the social network.

3. The computer-implemented method of claim 2 wherein:
generating the social network event includes defining a time, a date, and the physical location for the social network event; and
the electronic invitation includes the time, the date, and the physical location for the social network event.

4. The computer-implemented method of claim 2 wherein the location information is a uniform resource locator (URL).

5. The computer-implemented method of claim 2 further comprising:
enabling the non-user to view the first media content shared within the unrestricted web-based space.

6. The computer-implemented method of claim 2 further comprising:
receiving second media content that is associated with the social network event from the non-user.

7. The computer-implemented method of claim 6 further comprising:
sharing the second media content within the unrestricted web-based space; and
enabling the first user to view the second media content shared within the unrestricted web-based space.

8. The computer-implemented method of claim 2 further comprising:
generating a graphical user interface that includes a button that, upon selection, causes the graphical user interface to render an event window that includes fields for specifying a time, a date, and the physical location for the social network event.

9. The computer-implemented method of claim 6 wherein the second media content is chosen from the group consisting of: an audio file; a video file; an audio-video file; and a still photograph.

10. The computer-implemented method of claim 2 wherein the unrestricted web-based space is a non-indexable webpage.

11. The computer-implemented method of claim 2 further comprising
generating a graphical user interface that includes a schedule event button that, upon selection, causes the graphical user interface to render an event window that includes a field for inviting members of the social network to attend the social network event.

12. A computing system including a processor and memory configured to perform operations comprising:
generating a social network event on a social network, wherein the social network event corresponds to a physical location and wherein the social network event is attended by a first user of the social network;
sending an electronic invitation to a non-user of the social network to the social network event;
defining an unrestricted web-based space that is associated with the social network event on a computing device for sharing media content within the social network, wherein the unrestricted web-based space is accessible by the non-user of the social network;
receiving first media content that is associated with the social network event from the first user of the social network;
sharing the first media content within the unrestricted web-based space; and
enabling the first user to provide electronic location information concerning the unrestricted web-based space to a non-user of the social network.

13. The computing system of claim 12 wherein:
generating the social network event includes defining a time, a date, and the physical location for the social network event; and
the electronic invitation includes the time, the date, and the physical location for the social network event.

14. The computing system of claim 12 wherein the location information is a uniform resource locator (URL).

15. The computing system of claim 12 further configured to perform operations comprising:
enabling the non-user to view the first media content shared within the unrestricted web-based space.

16. The computing system of claim 12 further configured to perform operations comprising:
receiving second media content that is associated with the social network event from the non-user.

17. The computing system of claim 16 further configured to perform operations comprising:
sharing the second media content within the unrestricted web-based space; and
enabling the first user to view the second media content shared within the unrestricted web-based space.

18. The computing system of claim 12 further configured to perform operations comprising:
generating a graphical user interface to render an event window that includes fields for specifying a time, a date, and the physical location for the social network event.

19. The computing system of claim 16 wherein the second media content is chosen from the group consisting of: an audio file; a video file; an audio-video file; and a still photograph.

20. The computing system of claim 12 wherein the unrestricted web-based space is associated with a non-indexable webpage.

21. The computing system of claim 20 further configured to perform operations comprising:
generating a graphical user interface that includes a button that, upon selection, causes the graphical user interface to render an event window that includes fields for specifying a time, a date, and the physical location for the social network event.
